(19) United States
(12) Patent Application Publication
(10) Pub. No.: US 2008/0264233 A1
(43) Pub. Date: Oct. 30, 2008

(54) Bass drum mute

(76) Inventor: Robert A. Gatzen, Newington, CT (US)

Correspondence Address: ALIX YALE & RISTAS LLP, 750 MAIN STREET, SUITE 1400, HARTFORD, CT, 06103, US

(21) Appl. No.: 11/796,331

(22) Filed: Apr. 27, 2007

(51) Int. Cl. G10D 13/02

(52) U.S. Cl. 84/411 M

(57) ABSTRACT

A bass drum mute and a muted drum comprise a pad having a first face including a resilient first surface for bearing on the drumhead membrane and an opposite, second face including a second surface for receiving impacts from a beater. A mounting assembly is simultaneously engagable with the pad and the drum hoop or shell, for holding the first surface of the pad in fixed position bearing against the membrane while the second surface is exposed to the beater. The pad preferably comprises a block of self-supporting resilient material such as foam rubber with a striking region of firmer material. A channel spans the pad, with a cross bar insertable in the channel and having free ends extendable beyond the channel. A mounting end effector such as a clamp or suction cup is located on each free end of the cross bar, for attachment to the hoop or shell.

### BACKGROUND OF THE INVENTION

This invention relates generally to the field of musical drums and is more particularly directed to muting a bass drum while suppressing unwanted overtones and vibrations without detracting from the characteristics of desirable fundamental tones.

Bass drums have been particularly difficult to muffle adequately. Blankets and pillows of various types are commonly installed inside of the drum shell by individual drummers to serve as mufflers which are intended to decrease the overtones and rattles on the front head that result from striking of the batter head. Aside from the manifest problems caused by this technique, it does not effectively muffle the undesirable acoustical effects and is not uniform in its performance from one situation to another.

A special case of this problem, is sound dampening for the purpose of practicing. The drum set has different components (drums and cymbals) each of which requires a special dampening technique. The bass drum produces the most intrusive sound of all due to low frequency transmission. Controlling low frequency transmission is one of biggest issues when designing an “isolated” environment such as a practice room, recording studio, or mastering suite to audition music. Clearly, there is a need for an efficient and convenient method to dampen the bass drum without affecting the physical layout of the drum kit.

Previous inventions utilize a separate “stand” type design with a resilient (rubber) strike pad and a means of attaching the bass drum pedal. However, this type of design replaces the bass drum itself. It is important to note that the bass drum also provides a mounting system for other drum components such as toms, cymbals and percussion accessories, dictating the physical layout of the kit. Once the bass drum is removed, it is difficult to duplicate the “real” feel of the drum kit on various levels.

The bass drum utilizes the largest diameter drumhead of the drum kit. Depending upon musical style, drummers often use several different sized bass drums generally ranging from 16-26 inch diameters. This presents the problem of adjustability from a single device that effectively dampens low frequencies regardless of diameter size.

Even under ideal conditions, practicing a musical instrument is hard work, tedious, and difficult to manage. This is more difficult for drummers that practice on pad set-ups that are nothing more than a facsimile of the drum set environment. For example one who plays a guitar, trumpet, or piano, practices the actual instrument, not a simulation of it. This is a very important factor in regards to “stick-with-it-ness”.

There is a need for a simple and efficient mechanism that dampens the bass drum yet preserves the natural feel of the drum kit. Previous attempts to accomplish this goal have failed miserably due to complicated, inefficient design.

### SUMMARY

The foregoing problems have been solved by designing a special mute pad attachable to the bass drum, for providing a substantially constant dampening pressure against the surface of the head.

In one aspect, the mute comprises a pad having a first face including a resilient first surface for bearing on the bass drumhead membrane and an opposite, second face including a second surface for receiving impacts from a bass drum beater. Mounting means are simultaneously engagable with the pad and the hoop or shell, for holding the first surface of the pad in fixed position bearing against the membrane while the second surface is exposed to the beater.

In another aspect, the mute comprises a block of self-supporting resilient material having opposite, flat, first and second major faces, and a flat striking region of firmer material mounted on the second side of the block. A channel is formed in and spans the second face of the block. A cross bar is insertable in the channel and has free ends extendable beyond the channel. A mounting end effector such as a clamp or suction cup is located on each free end of the cross bar, for attachment to the hoop or shell.

Yet another aspect is directed to a muted bass drum comprising a vertically oriented beater drumhead at one end of the shell, a hoop secured to the shell at the shell diameter for mounting the drumhead to the shell, whereby the drumhead presents a circular membrane having a surface area defined by the shell diameter and held in tension within the hoop. A foot pedal is spaced from the drumhead and operatively associated with a beater located and sized to strike an impact zone on the drumhead membrane. A muffling pad having a first face including a resilient first surface covers the impact zone and bears on the bass drum membrane. An opposite, second face is located over the impact zone for receiving impacts from the beater. Mounting means are simultaneously engaged with the second face of the muffling pad and the hoop or shell, for holding the first surface of the pad in fixed position against the membrane while the second surface is exposed to the beater.

Preferably, the mute is formed from a combination of two materials having different resilience at the first and second surfaces, such as foam rubber and solid or natural rubber to produce natural rebound and feel from the drum pedal beater. This preserves the natural feel of the drum set, encouraging drummers to practice with greater satisfaction and commitment.

For increased convenience and flexibility, the mute is fully adjustable, allowing a single unit to fit all sizes of bass drums.

Preferably, the static or installation pressure exerted by the mute on the drumhead membrane can be adjusted, thereby creating variations in tone, feel and dampening levels. At minimum dampening settings, sufficient volume and tone levels can be achieved for actual live or recording situations.

A drum mute according to the invention can be attached to both batter and resonant drumheads for maximum dampening.

### DESCRIPTION OF THE DRAWING

In the accompanying drawing, like reference numerals are used to indicate like parts in the various views:

FIG. 1 is a perspective view of a cutaway portion of a conventional snare drum located next to a bass drum equipped with a mute according to one embodiment of the present invention;

FIG. 2 is a plan view of a mute similar to the mute shown in FIG. 1, before installation;

FIG. 3 is an elevation view of the mute of FIG. 2, situated immediately above the bass drum head in the course of installation with clamps onto the counter hoop of the bass drum shown in FIG. 1;

FIG. 4 is a side view from the right, of the mute shown in FIG. 2;

FIG. 5 is an exploded view of the mute shown in FIG. 2; and

FIG. 6 is an elevation view of another embodiment, having suction cup end-effectors for installation onto the counter hoop.

### DETAILED DESCRIPTION

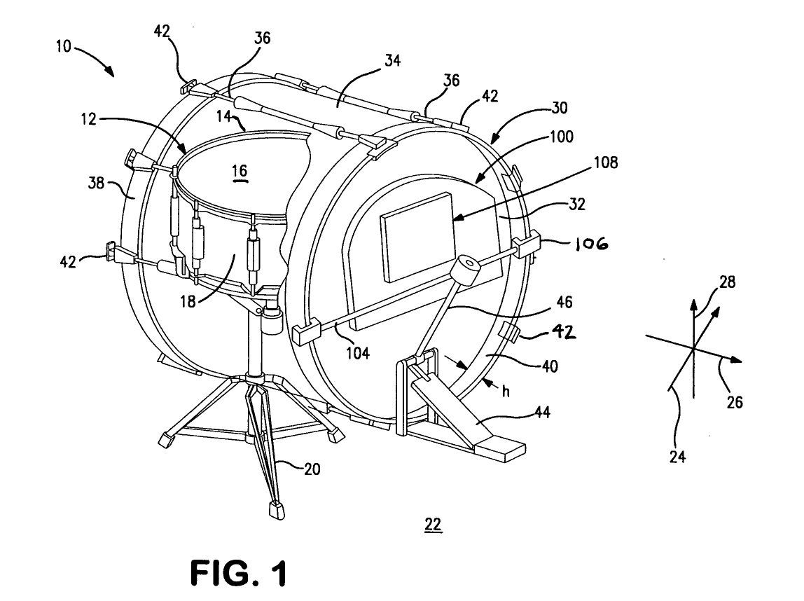

Referring now to the drawings in more detail and initially to FIG. 1, numeral 10 generally designates a portion of a drum set or kit including a cutaway of snare drum 12 mounted on a stand 20 resting on a floor 22 or the like. The snare drum 12 is constructed conventionally with a drumhead 14 made of a thin polyester film 16 forming a drumhead sheet having a planar circular surface that forms the playing surface of the drum. The film 16 is stretched across the upper end of a cylindrical drum shell 18 and mounted thereto in a conventional manner not germane to the present invention and therefore not shown in detail. The floor establishes orthogonal horizontal directions 24, 26 and vertical direction 28.

FIG. 1 also shows a bass drum 30 having a mute 100 in accordance with one embodiment of the present invention.

The bass drum 30 is constructed conventionally, with a batter head 32 visible in the figure and an opposite front or resonant head (not shown). The bass drum 30 includes a cylindrical shell 34 centered on a horizontal axis parallel to direction 26, and tension rods 36, which act against counter hoops 38 and 40 to adjust the tension of the circular front head and batter head 32. The heads extend vertically, parallel to direction 28. Tee handles 42 are provided for adjustment of the tension rods 36. The hoops 38, 40 rise above the circular plane of the playing surface of drumhead 32, by a height h of about one to two inch in direction 26. The bass drum 30 is also equipped with a pedal 44 resting on floor 22, which can be depressed with the foot in order to drive the associated pivot shaft and beater 46 against the batter head 32.

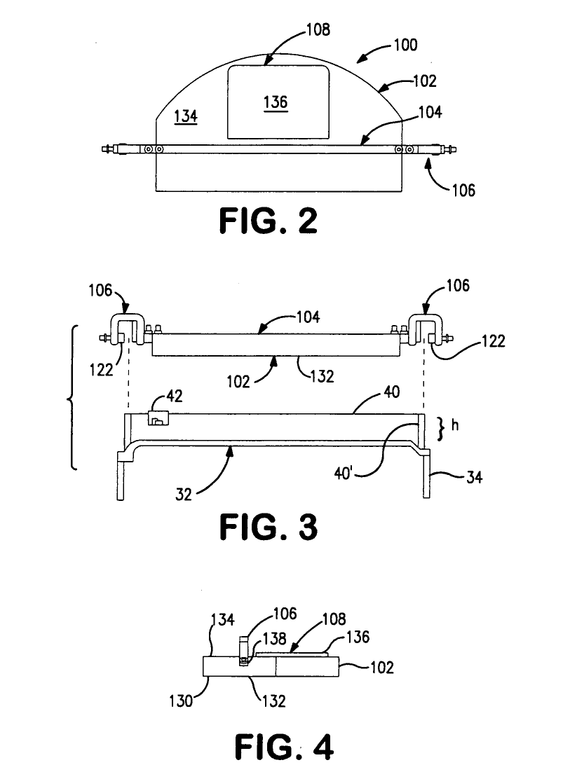

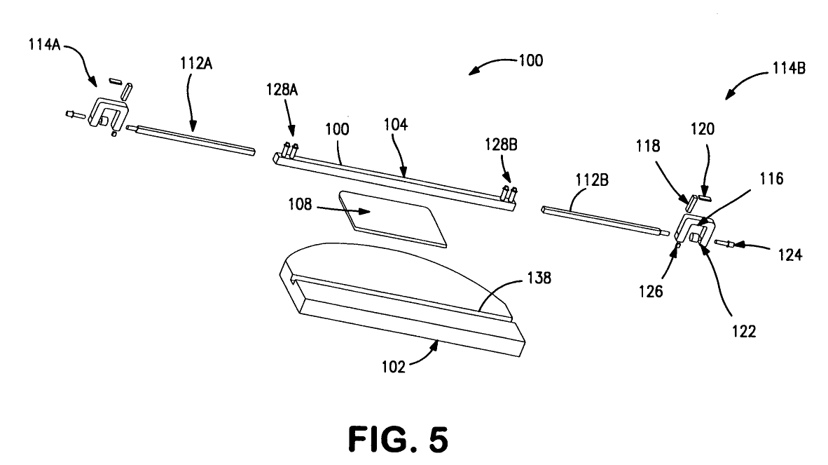

FIGS. 2-5 show details of a variation of the embodiment of the mute 100 shown in FIG. 1. In the preferred embodiment, the mute comprises four components: a resilient muffling pad 102, a cross bar 104 that spans the exposed surface of the pad 102, clamp assemblies on the cross bar, such as “C” clamps 106, and a strike pad 108 on the exposed surface of the muffling pad.

The muffling pad 102 is preferably a substantially self-supporting, flat block of resilient material, such as foam rubber. Self-supporting in this context means the block has sufficient rigidity that when held in the hand along one edge, the block remains substantially flat. This degree of rigidity distributes the force applied to the muffling pad 102 by the relatively narrow cross bar 104 and by the beater 46, over a wide area of the drumhead. The block is sufficiently resilient, however, that it does not vibrate in sympathy with the vibration of the drumhead membrane when the beater 46 impacts the strike pad 108. The muffling pad 102 thereby both transmits the impulse of the beater 46 to the drumhead membrane with sufficient pressure to produce the characteristic attack and sustain of a bass drum, while dampening the amplitude and overtones of the membrane.

The preferred cross bar 104 is rigid but has a hollow central section 110 and left and right extension rods 112A, 112B that can slide within the central section, thereby adjusting the distance between the respective clamp assemblies 114A, 114B.

Each clamp assembly 114 preferably includes a “C” or “U” clamp 116, having its open side facing the drumhead counter hoop 40 during installation. Rubber liners 116, 118 can be provided on the outside of the inner leg and bass of the clamp. A screw cap 122 extends from the inside of the outer leg of the C clamp, toward the inner leg, and a lug 124 penetrates the outer leg of the clamp and engages the screw cap 122, for moving the screw cap 122 toward or away from the counter hoop 40 during instillation or removal of the mute. The outer end of extension rod 112 has a nose that enters a hole in the inner leg of the clamp, and set screw 126 can be advanced in a threaded bore transverse to the hole, for attaching the clamp to the outer end of the extension rod 112.

Lugs 128A and 128B are carried in threaded bores at opposite ends of the central section 110, for engaging the inner ends of the respective extension rods 114A, 114B, to fix the distance between the clamping assemblies 112A, 112B, according to the diameter of the bass drum. In this manner, one mute 100 can be adjusted for installation on any size bass drum, e.g., having a drumhead diameter in the range of 16 to 26 inches.

Once the extension rods have been set according to the drumhead size, the mute 100 is placed over the drumhead as depicted in FIG. 3. The mute 100 is lowered such that the first surface on the first side of the muffling pad 102 contacts the membrane of drumhead 32, at which moment the clamps will surround the upright rim of the counter hoops 40. The rim projects a fixed distance h, typically one to two inches, from the plane of the membrane. The clamp can be secured via advancing of the screw caps 122 onto the outside of the rim, at almost any elevation along the height h of the rim. Because the cross bar 104 and clamp assemblies 114 are rigidly connected, and the cross bar spans the muffling pad 102, the lower the screw caps 122 are attached to the rim along height h, the more pressure the muffling pad 102 will exert on the membrane in the neutral position.

The positional flexibility in the attachment of the C clamps thus allows variations in pressure against the head surface, which in turn alters the tone and feel of the drum, thereby providing a degree of custom fitting for each drummer's personal preferences. Minimal dampening settings will provide adequate sound volume for actual performance situations where a “quiet” bass drum sound is required. Also this technique can apply to recording environments to create specialized bass drum sounds. Tuning the drum at a high-tension setting will provide a single dense thump-type tone while low (less tension) tunings will create more “attack”. The low setting best simulates what drummers refer to as “slap” sound.

Apart from tone and feel, the level of dampening can be controlled not only by adjusting the pressure of the muffling pad against the head, but also optionally utilizing two mutes for maximum dampening, one mounted on the batter head and the other, on the front or resonant head.

Another advantage is that the mute is easily attached and removed from the bass drum and is compact in size, allowing the drummer to easily transport it. Furthermore, the ease of transportability and adjustability, permit a given drummer who owns a given mute used on that drummer's bass drum or drums, to readily install that mute on other bass drums

In a more general implementation, the mute comprises a pad 102 having a first face 130 including a resilient first surface 132 for bearing on the bass drum membrane and an opposite, second face 134 including a firmer second surface 136 for receiving impacts from a bass drum beater 46, and mounting means 104, 106 simultaneously engagable with the second face 134 of the pad and preferably at least two locations on one of the hoop 40 and shell 34, for holding the first surface 132 of the pad in fixed position bearing against the membrane while the second surface 136 is exposed to the beater. Although not shown, a single mounting point on the hoop or shell, or two mounting points on the hoop and shell, can be equivalent mounting means provided they produce sufficient pressure between the first surface 132 of the pad and the membrane, to stabilized the pad and consistently dampen the vibration of the membrane.

The muffling pad can be a monolithic, homogenous block of self-supporting resilient material having opposite, flat, first and second major faces, if a single material has both the resilience needed at the first face 130 for dampening and the strike response and wear resistance needed at the strike zone on the second face 134, where the beater impacts the pad. Alternatively, the pad can be a composite or laminate, with the first surface having the required resilience and the second surface defining a flat striking region of firmer material. One option is to have a relatively rigid substrate defining the second face and an adhered resilient pad defining the first face.

The mute will typically have a uniform thickness of about one to two inches. Preferably, the perimeter is a segment of a circle on a rectangle, with the strike region or pad located at least in part in the circular segment and the channel and/or cross bar spanning the rectangle. The area of each of the first and second faces is preferably in the range of 0.5 to 2.0 square feet, most preferably about 0.7 to 1.8 square feet. Preferably, the exposed, second face 134 of the muffling pad 102 has a recessed channel 138 formed in and spanning the second face 134 of the block. The cross bar 104 is insertable in the channel, preferably to a depth such that the cross bar does not project above the second face 134 to a significant extent (which might otherwise interfere with the pivoting shaft of the beater 46). Also, the strike pad 108 can extend over the channel as shown in the variation of FIG. 1.

As also shown in FIG. 1, the mute 100 is preferably mounted such that the cross bar 104 extends horizontally in direction 24 across the horizontal diameter of the drumhead 32. Furthermore, having the cross bar 104 so oriented and at least partially within the channel 138, enables the cross bar to provide the secondary function of resisting the effect of gravity pulling on the pad 102 vertically downward in direction 28, which would induce a sliding at the interface of the pad and membrane, especially if the installation pressure has been set to a minimal level and the drummer vigorously beats the drumhead.

Thus, the embodiment of a muted bass drum 30 comprises a cylindrical shell 34 having a horizontal axis and a shell diameter, a vertically oriented beater drumhead 32 at one end of the shell, and the mute 100 installed on the outside surface of the drumhead to impose some pressure on that drumhead. As previously described, a hoop 40 secures the drumhead to the shell 34 at the shell diameter and a circular membrane having a surface area is defined by the shell diameter and held in tension within the hoop. A foot pedal 44 is spaced from the drumhead and is operatively associated with a beater 46 located and sized to strike an impact zone on the drumhead membrane. A pad 102 has a first face 130 including a resilient first surface 132 covering the impact zone and bearing on the bass drum membrane and an opposite, second face 134 including a firmer, less resilient second surface 136 located over the impact zone for receiving impacts from the beater. Mounting means 106 simultaneously engage the second face 134 of the pad at preferably two locations on one of the hoop and shell, for holding the first surface 132 of the pad in fixed position against the membrane while the second surface 136 is exposed to the beater. Preferably, the mounting means is a cross bar 104 that spans the pad 102 and is attached to the hoop 40 at the opposite ends of a horizontal diameter across the vertical drumhead 32.

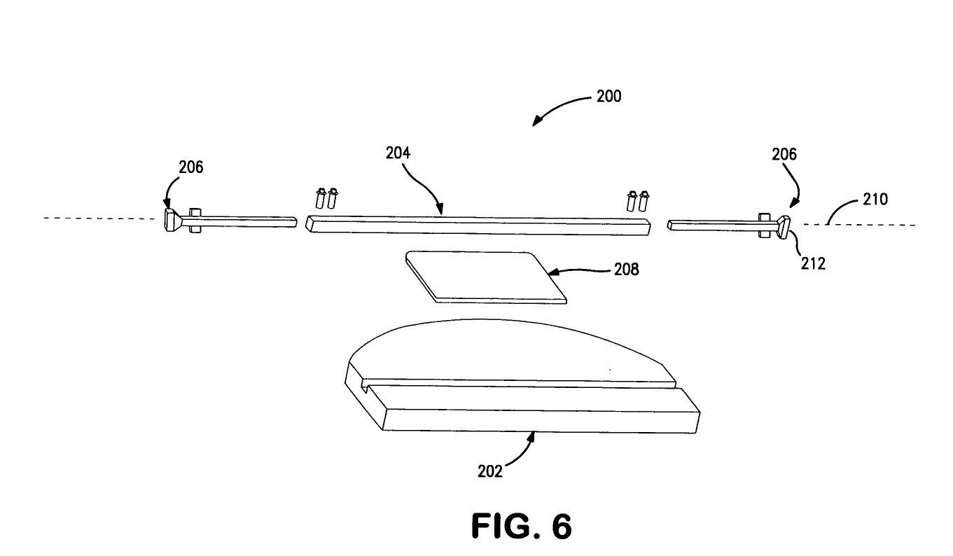

FIG. 6 shows another mute embodiment 200, wherein the pad 202, cross bar 204, and strike region 208 are as described with respect to FIGS. 1-5, but the end effectors are suction cups 206 instead of clamps. The axis 210 of each suction cup is aligned with the axis of the cross bar 204, whereby the circular rim 212 of each cup can engage the inner side 40′ of the hoop 40 (see FIG. 3). To install, the cross bar is adjusted to approximate the inner diameter of the hoop rim, and the cross bar length on one side fixed. With the cross bar situated on or in the exposed surface of the pad, the user presses one end of the cross bar against one inner side of the hoop, then slightly extends the other end of the cross bar to bear with pressure against the opposite inner side of the hoop. With the pad bearing on the membrane and both cups urged against the hoop, the user the fixes the length of the other end of the cross bar.

The details associated with the embodiments as described herein should not be understood as restricting the claims with limitations not expressly recited therein.

1. A mute for a bass drum having a cylindrical shell, a circular drumhead including a membrane, and a drumhead counter hoop attachable to the shell, comprising;
a pad having a first face including a resilient first surface for bearing on the bass drum membrane and an opposite, second face including a strike region for receiving impacts from a bass drum beater; and
mounting means simultaneously engagable with the pad and at least two locations on one of the hoop and shell, for holding the first surface of the pad in fixed position bearing against the membrane while said second surface is exposed to the beater.

2. The mute of claim 1, wherein the pad is a substantially self-supporting block.

3. The mute of claim 2, wherein the strike region comprises a beater strike pad mounted to the block.

4. The mute of claim 1, wherein the surface of the strike region is firmer than the resilient first surface on the first side of the pad.

5. The mute of claim 1, wherein the mounting means includes a clamp assembly engagable with the counter hoop.

6. The mute of claim 1, wherein the mounting means includes a rigid cross bar of adjustable length, having a clamp assembly on each end.

7. The mute of claim 6, wherein the clamp assembly includes a clamp having a base and two legs, an open region between the legs for entry of the counter hoop, and means mounted in a leg for advancing into said open region and bearing on the hop when the hoop is within said open region.

8. The mute of claim 1, wherein the mounting means includes a suction cup for engaging the counter hoop.

9. The mute of claim 1 wherein the mounting means includes a rigid cross bar of adjustable length, having a suction cup at each end.

10. The mute of claim 1, wherein the pad includes a channel spanning the pad and the mounting means includes a cross bar having a cross section that fits within the channel.

11. The mute of claim 1, wherein the mounting means is engagable with the second face of the pad.

12. The mute of claim 11, wherein
the pad is a substantially self-supporting block of resilient foam material;
the strike region comprises a beater strike pad mounted to the block, having a strike surface that is firmer than the first surface on the first side of the pad;
the pad includes a recessed channel spanning the second face of the pad; and
the mounting means includes a cross bar having a cross section that fits within the channel.

13. The mute of claim 1, wherein the first face of the pad has a first surface area of at least about 0.5 square feet.

14. The mute of claim 1, wherein the first face of the pad has a first surface area of between about 0.7 and 1.8 square feet.

15. The mute of claim 1, wherein the pad is foam rubber having a uniform thickness of about one to two inches.

16. The mute of claim 1, wherein
the pad has a perimeter defined by a segment of a circle on a rectangle;
the strike region is located at least in part in the segment of the circle; and
the mounting means includes a channel and cross bar in the channel, spanning the rectangle.

17. A bass drum mute comprising:
a block of self-supporting resilient material having opposite, flat, first and second major faces;
a flat striking region of firmer material mounted on the second side of the block;
a channel formed in and spanning the second face of the block;
a cross bar insertable in the channel and having free ends extending beyond the channel; and
a mounting end effector on each free end of the cross bar.

18. The bass drum mute of claim 17, wherein the cross bar has an adjustable length.

19. The bass drum mute of claim 17, wherein the end effector is a clamp.

20. The bass drum mute of claim 17, wherein the end effector is a suction cup.

21. A muted bass drum comprising:
a cylindrical shell having a horizontal axis and a shell diameter;
a vertically oriented beater drumhead at one end of the shell, including a circular membrane having a surface area defined by said shell diameter;
a hoop secured to the shell at said shell diameter for mounting the drumhead to the shell and holding the membrane in tension within the hoop;
a foot pedal spaced from the drumhead and operatively associated with a beater located and sized to strike an impact zone in the drumhead membrane;
a muffling pad having a first face including a resilient first surface covering the impact zone and bearing on the bass drum membrane and an opposite, second face including a second surface located over the impact zone for receiving impacts from the beater; and
mounting means simultaneously engaged with the second face of the muffling pad and one of the hoop and shell, for holding the first surface of the pad in fixed position against the membrane while said second surface is exposed to the beater.

22. The muted bass drum of claim 21, wherein the mounting means is engaged with diametrically opposed locations on the hoop.

23. The muted bass drum of claim 21, wherein said second surface is a firmer material than said first surface.

24. The muted bass drum of claim 21, wherein the pad is a substantially self-supporting block.

25. The muted bass drum of claim 21, wherein
the pad is a block of substantially self-supporting resilient foam material;
the second surface defines a flat striking region of firmer material mounted on the second side of the block;
a channel is formed in and spans the second face of the block;
a cross bar is situated in the channel and has free ends extending beyond the channel; and
a mounting end effector on each free end of the cross bar is engaged with diametrically opposed locations on the hoop.
